(19) United States
(12) Patent Application Publication
(10) Pub. No.: US 2004/0133311 A1
(43) Pub. Date: Jul. 8, 2004

(54) Artificial intelligence robot toy and control method thereof

(76) Inventors: Chang-Bae Park, Seoul (KR); Dae-Kyung Kim, Gyeonggi-do (KR); Nam-Yong Lee, Gyeonggi-do (KR)

Correspondence Address: JACOBSON HOLMAN PLLC, 400 SEVENTH STREET N.W., SUITE 600, WASHINGTON, DC, 20004, US

(21) Appl. No.: 10/740,612

(22) Filed: Dec. 22, 2003

(30) Foreign Application Priority Data
Jan. 3, 2003 (KR) 2003-0000254

(51) Int. Cl. G06F 19/00

(52) U.S. Cl. 700/245

(57) ABSTRACT

Disclosed is an artificial intelligence robot toy that can be easily assembled and controlled in various shapes by using one kind of joint motor. The robot toy includes: a plurality of joint mechanism parts assemblable and disassemblable to form various shapes of robots; a master main-processor unit board provided in one of the plurality of joint mechanism parts, for outputting a robot control signal such that another joint mechanism parts have a predetermined operation pattern; a plurality of joint control means respectively provided in the remaining joint mechanism parts other than the selected joint mechanism part, for transmitting and receiving data to and from the master main-processor unit board while operating the corresponding joint mechanism parts by using at least one pattern, based on the operation pattern of the master main-processor unit board; and a joint means for coupling the plurality of joint mechanism parts so as to form the various shapes of robots. The inventive robot toy can address all functions to a maximum degree at a low manufacturing cost and to extend, assemble and control the robot toys in various shapes with ease.

### BACKGROUND OF THE INVENTION

1. Field of the Invention

The present invention relates to an artificial intelligence robot toy, and more specifically, to an artificial intelligence robot toy that can be easily assembled and controlled in various shapes by using one kind of joint motor. In particular, the present invention is directed toward an artificial intelligence robot toy and control method thereof in which additional extension of the joint is compatible with the easiness in the modification design and coping design.

2. Description of the Related Art

In general, toys, particularly, robot toys needing motions are classified into a highgrade type in which a motor is driven by an electric power, and a simple type using a mainspring or the like. The highgrade type robot toys are controlled by a wireless remote controller or a wiring remote controller, and are moved by controlling a motor operation inside the body to move joints.

In the controls of the robot toys using such remote controllers, whoever is skilled to the handling of the remote controller can control the robot toys, but users who are not accustomed to the handling of the remote controller do not feel interest and love in the robot toys. In particular, after operating all the functions of such robot toys that request a motion as above several times, a user is easily fed up and carefree with the robot toys, so that there exists a drawback in that the real use lifecycle of these robot toys is short.

Also, since the robot toys moved using joints are marketable in the form of a single product, it is impossible that a user extends an assembly structure of one set robot toy to various shapes, for instance, puppy robot, dinosaur robot, or android. In particular, for mechanical assembling of electronic circuit and control circuit used for controlling joints, particular apparatuses and high costs are required, which is burdensome to general users. In addition, when motor or control circuit is disordered or robot mechanism is fractured, what the repair of the disorder is impossible is indicated as a problem.

### SUMMARY OF THE INVENTION

Accordingly, it is desirable to provide a robot toy that can solve the above problems, is low in aspect of costs, is variously expandable and contractible in shape in aspect of reliability, and can be assembled with ease.

An object of the present invention is to provide an artificial intelligence robot toy and control method thereof in which various shapes of robot toys requesting motions using one kind of joint motor are easily assemblable, changeable in shape, and controllable.

Another object of the present invention is to provide an artificial intelligence robot toy and control method thereof in which the respective parts including leg are assemblable in an independent unit, and the assembling time and the number of parts are reduced substantially.

A further object of the present invention is to provide an artificial intelligence robot toy in which additional extension of joint, modification design of the robot toy and disorder coping are easy.

A further another object of the present invention is to provide an artificial intelligence robot toy in which proper motion and response are performed according to various shapes of robot mechanisms, and price competitiveness and motion reliability are secured.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an artificial intelligence robot toy comprising: a plurality of joint mechanism parts assemblable and disassemblable to form various shapes of robots; a master main-processor unit board provided in one of the plurality of joint mechanism parts, for outputting a robot control signal such that another joint mechanism parts have a predetermined operation pattern; a plurality of joint control means respectively provided in the remaining joint mechanism parts other than the selected joint mechanism part, for transmitting and receiving data to and from the master main-processor unit board while operating the corresponding joint mechanism parts by using at least one pattern, based on the operation pattern of the master main-processor unit board; and a joint means for coupling the plurality of joint mechanism parts so as to form the various shapes of robots.

Alternatively, the joint mechanism part comprises: a lower case provided with a guide part formed at one end thereof, an opening formed at the other end thereof, and a coupling hole formed at an outer wall thereof such that the joint means is inserted; a housing coupled in the lower case, for stably supporting the master main-processor unit board or the joint control means, the housing having a gear shaft coupled with the joint means at one end of the housing and protruded in a vertical direction to be rotatable, and an insertion part onto which the joint means is inserted; an upper case coupled with the lower case and having an slot formed at a side sealingly closing the housing; and a coupling shaft extending from an end of the gear shaft and protruded through the slot of the upper case, the coupling shaft being coupled with the joint means.

Alternatively, the joint control means comprises: an inverse power preventing part supplied with a non-driving voltage to prevent an inverse voltage; a constant voltage part for converting and outputting the output non-driving voltage of the inverse power preventing part to a constant level of digital voltage; a filter part for filtering a noise including a ripple voltage from the supply voltage of the constant voltage part and supplying a filtered voltage; a voltage detecting part for detecting level of the non-driving voltage obtained from the inverse power preventing part; a motor coupled to the housing of the joint mechanism part and rotating clockwise or counterclockwise; a motor driving part for controlling and driving the motor in a pulse width modulation (PWM) way according to the voltage obtained by the constant voltage part and the inverse power preventing part; a gear part coupled to a shaft of the motor, for decelerating a rotational ratio of the motor, transferring the decelerated rotational ratio to the gear shaft, and controlling the operation pattern of the joint mechanism part; a rotation sensing part driven by the supply voltage of the filter part, for sensing the rotation of the gear part; a current detecting part for detecting a load current of the motor through the motor driving part; first to third A/D converters for converting and outputting the output signals of the voltage detecting part, the current detecting part and the rotation sensing part to digital signals respectively; and a main-processor unit for outputting a PWM signal and a direction signal depending on operation modes provided from the master main-processor unit board to drive the motor and respectively computing the voltage level, the current level and the rotational ratio obtained by the first to third A/D converters and transmitting the computed voltage level, the current level and the rotational ratio to the master main-processor unit board.

In an aspect of the present invention, there is provided a method for controlling an artificial intelligence robot toy, the method comprising the steps of: (a) determining a current position of joints from a rotation sensing part informing a current position of joint mechanism parts; (b) obtaining an error from the determined current position and a target position provided by a master main-processor unit board; (c) computing a variation rate of the obtained error and then performing a proportional differential control arithmetic of the computed variation rate; (d) calculating an application voltage of motors provided from the master main-processor unit board and detecting a current of the motors while supplying the calculated voltage; and (e) determining whether or not the detected current exceeds a limit current, when it is determined that the detected current exceeds the limit current, cutting off the voltage applied to the motors, and when it is determined that the detected current does not exceed the limit current, repeating the steps after the step (a).

According to the present invention, various shapes of robot toys requesting motions are easily assemblable using one kind of joint motor.

As a result, it is possible to issue all the functions of the robot toy at a low manufacturing cost. Also, various shapes of robot mechanisms are more easily expandable, assemblable and controllable. Further, disorder coping is easy.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an artificial intelligence robot toy according to the present invention;

FIGS. 2A and 2B are flowcharts illustrating operation flows of an artificial intelligence robot toy according to the present invention;

FIGS. 3A and 3B are disassembled perspective views of a joint mechanism part in an artificial intelligence robot toy according to the present invention;

FIGS. 4A and 4B to FIGS. 7A and 7B are perspective views of first to eleventh joint parts configured to couple the joint mechanism part;

FIGS. 8A to 18A are disassembled perspective views illustrating coupling states between the joint mechanism part and the first to eleventh joint parts;

FIGS. 8B to 18B are assembled perspective views illustrating coupling states between the joint mechanism part and the first to eleventh joint parts;

FIG. 19 is a perspective view of a coupling state according to an embodiment of the present invention; and

FIG. 20 is a coupling state of a robot toy according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

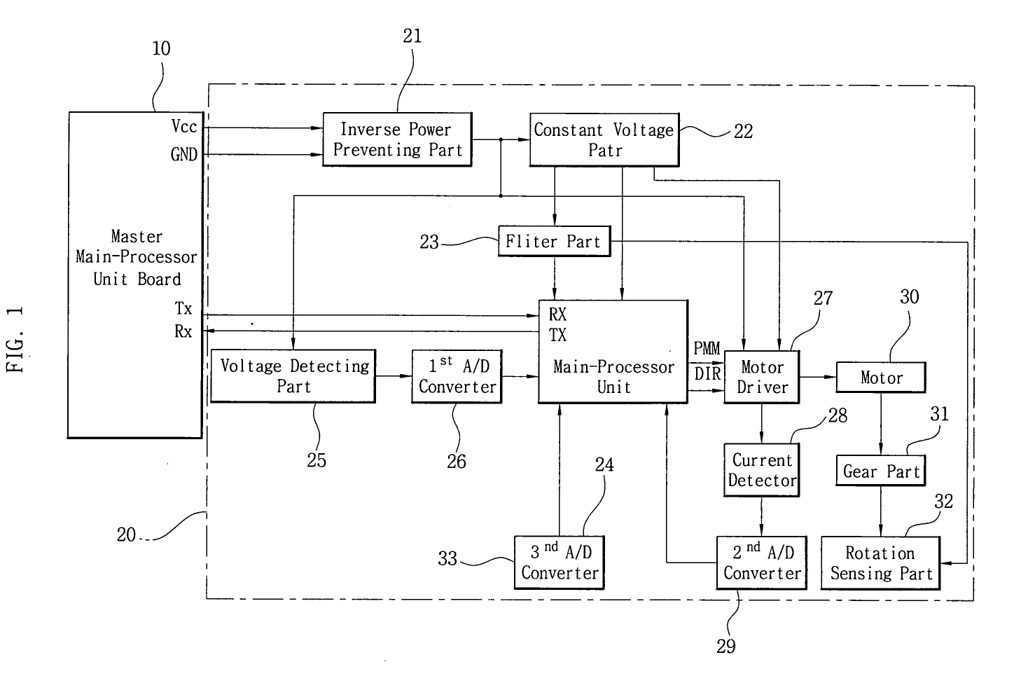

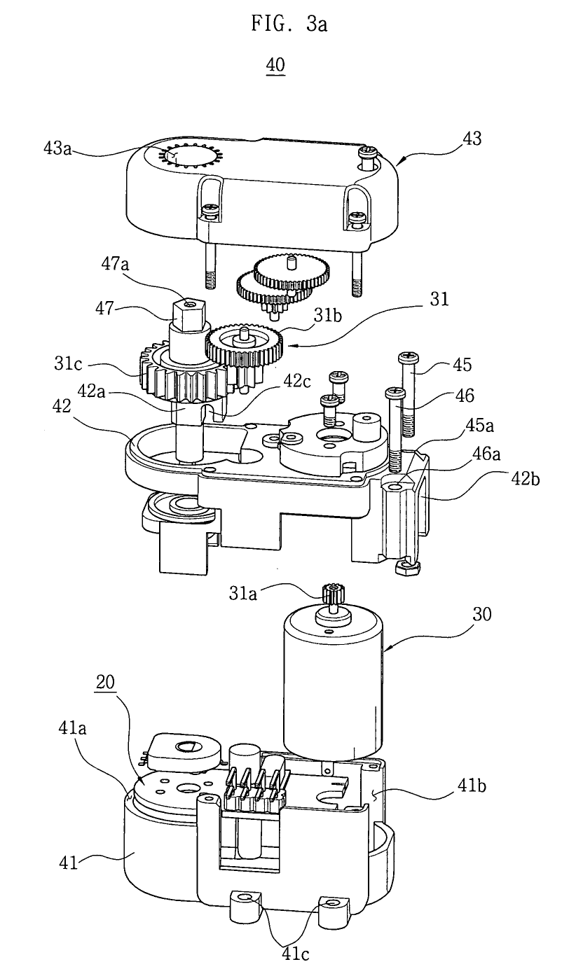

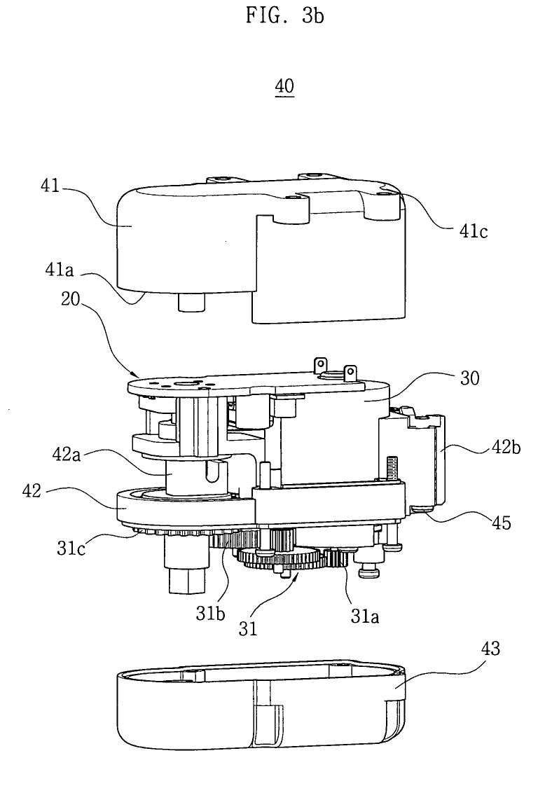

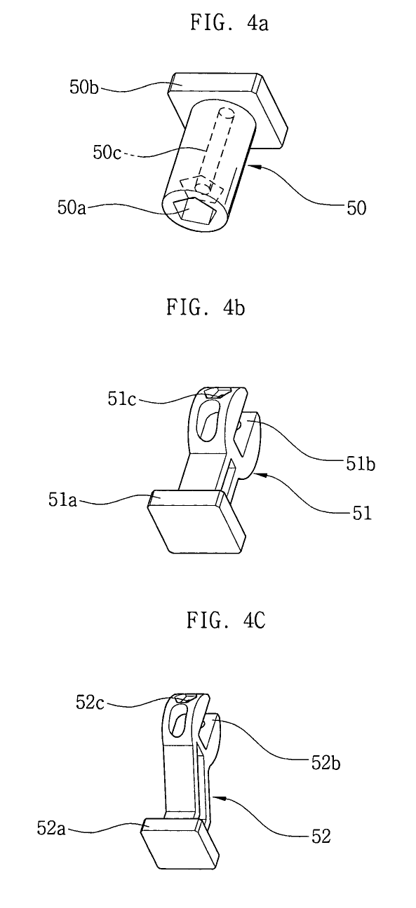

FIG. 1 is a block diagram of an artificial intelligence robot toy according to the present invention, FIGS. 3A and 3B are disassembled perspective views of a joint mechanism part in an artificial intelligence robot toy according to the present invention, and FIGS. 4A and 4B to FIGS. 7A and 7B are perspective views of first to eleventh joint parts configured to couple the joint mechanism part.

In an embodiment of the present invention, as shown in FIGS. 1 and 3, an artificial intelligence robot toy includes: a plurality of joint mechanism parts 40 assemblable and disassemblable to form various shapes of robots; a master main-processor unit board 10 provided in any one of the plurality of joint mechanism parts 40, for outputting a robot control signal such that another joint mechanism parts have a predetermined operation pattern; a plurality of joint control part 20 respectively provided in the remaining joint mechanism parts, for transmitting and receiving data to and from the master main-processor unit board 10 while operating the corresponding joint mechanism parts by using at least one pattern, based on the operation pattern of the master main-processor unit board 10; and first to eleventh joint parts 50 to 60 for coupling the plurality of joint mechanism parts 40 so as to form the various shapes of robots.

As shown in FIGS. 3A and 3B, the joint mechanism part 40 includes: a lower case 41 provided with a guide part 41a formed at one end thereof, an opening 41b formed at the other end thereof facing the guide part 41a, and two coupling holes 41c formed protruded outwardly from an outer wall thereof such that the second to fifth joint parts 51 to 54 are inserted; a housing 42 coupled to the lower case 41, the housing 42 being coupled with the master main-processor unit board 10 or the joint control part 20 at a side surface of the housing 10, coupled with the rotatable gear shaft 42a at one end thereof, the gear shaft 42a being protruded in a vertical direction and having a screw hole 42c such that the second to fifth joint parts 51 to 54 are coupled attachable or detachable, the housing 42 having a rectangular insertion part 42b of which one surface is opened and which the first to third joint parts 50 to 53, sixth, seventh and eleventh joint part 55, 56 and 60 are detachably inserted into and coupled to, and screw holes 45a and 46a formed at both sidewalls of the insertion part 42b in a vertical direction and coupled by two screws 45 and 46 inserted therein and nuts from a lower direction means is inserted; an upper case 43 coupled with the lower case 41 by four screws and having a slot 43a formed at one end configured to sealingly close the housing 42; and a pentagonal coupling shaft 47 formed extending from an end of the gear shaft 42a and protruded through the slot 43a of the upper case 43, the coupling shaft having a screw hole 47a at an upper center thereof where the first, fifth, ninth and tenth joint parts 50, 54, 58 and 59 are detachably coupled.

Referring to again FIG. 1, the joint control part 20 includes: an inverse power preventing part 21 supplied with a non-driving voltage of the master main-processor unit board 10 to prevent an inverse voltage input to the master main-processor unit board 10; a constant voltage part 22 for converting and outputting the output non-driving voltage of the inverse power preventing part 21 to a constant level of digital voltage; a filter part 23 for filtering a noise including a ripple voltage from the supply voltage of the constant voltage part 22 and supplying a filtered voltage; a voltage detecting part 25 for detecting level of the non-driving voltage inputted from the inverse power preventing part 21 and outputting a resultant voltage; a motor 30 coupled to a lower surface of the housing 42 of the joint mechanism part 40 by two screws and rotating clockwise or counterclockwise; a motor driving part 27 for controlling and driving the motor 30 in a pulse width modulation (PWM) way according to the voltages obtained by the constant voltage part 22 and the inverse power preventing part 21; a gear part 31 coupled to a shaft of the motor 30 penetrating an upper surface of the housing 42, for decelerating a rotational ratio of the motor 30, transferring the decelerated rotational ratio to the gear shaft 42a, and controlling the operation pattern of the joint mechanism part 40; a rotation sensing part 32 driven by the supply voltage of the filter part 23, for sensing the rotation of the gear part 31; a current detecting part 28 for detecting a load current of the motor 30 through the motor driving part 27; first to third A/D converters 26, 28 and 33 for converting and outputting the output signals of the voltage detecting part 25, the current detecting part 28 and the rotation sensing part 32 to digital signals respectively; and a main-processor unit 24 for outputting a pulse width modulation (PWM) signal and a direction (DIR) signal depending on operation modes provided from the master main-processor unit board 10 to control the operation of the motor 30 through the motor driving part 27 and respectively computing the voltage level, the current level and the rotational ratio obtained by the first to third A/D converters 26, 28 and 33 and transmitting the computed voltage level, the current level and the rotational ratio to the master main-processor unit board received in any one of the joint mechanism parts.

The gear part 31, as shown in FIGS. 3A and 3B, includes a first gear 31a coupled to the shaft of the motor 30 protruded through the upper surface of the housing 42 and rotated, a second gear in mesh with the first gear 31a, and a third gear 31c formed in the gear shaft 42a of the joint mechanism part 40, and in mesh with the second gear 31b to decelerate the rotational ratio.

As shown in FIG. 4a, the first joint part 50 is a cylindrical shaft having a predetermined length, the cylindrical shaft having a pentagonal insertion groove 50a formed at one end thereof and a rectangular insertion piece 50b formed at the other end thereof such that the joint part 50 is inserted onto the coupling shaft 47 through the slot 43a of the joint mechanism part 40 and inserted into the insertion part 42b through the guide part 41a of the another joint mechanism parts. Also, the first joint part 50 has a vertical penetration hole 50c penetrating from the pentagonal insertion groove 50a to the insertion piece 50b.

As shown in FIGS. 4b and 4c, each of the second and third joint parts 51 and 52 has a spanner type insertion hole 51b, 52b with an axial hole 51c, 52c formed at one end of a shaft thereof and a rectangular insertion piece 51a, 52a formed at the other end of the shaft so as to be inserted onto the gear shaft 42a and the insertion parts 42b of the another joint mechanism parts through the guide part 40 of the one joint mechanism part 40. Herein, the shaft of the second joint part 51 is a straight-line type that is short in length between the insertion hole 51b and the insertion piece 51a, while the shaft of the third joint part 52 is a curved type that is long in length between the insertion hole 52b and the insertion piece 52a.

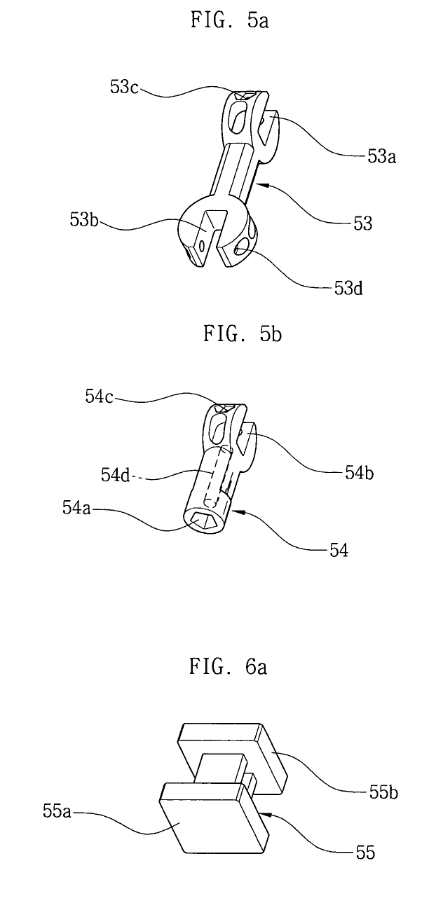

As shown in FIG. 5A, the fourth joint part 53 has spanner type insertion holes 53a and 53b formed at both ends of a shaft thereof so as to be inserted onto the gear shaft 42a through the gear shaft 42a of the one joint mechanism part 40 and the guide part 41a of other joint mechanism parts. Both insertion holes 53a and 53b of the fourth joint part 53 are arranged at an angle of 90 degrees referenced on the shaft.

As shown in FIG. 5b, the fifth joint part 54 has a pentagonal insertion groove 54a formed at one end thereof and a spanner type insertion hole 54b formed at the other end thereof so as to be respectively inserted onto the coupling shaft 47 through the slot 43a of the one joint mechanism part and inserted onto the gear shaft 42a through the guide part 41a of the another joint mechanism parts. Also, the fifth joint part 54 has a vertical penetration hole penetrating from the pentagonal insertion groove 54a to the insertion hole 54b, and an axial hole 54c formed at the insertion hole 54b side to is perpendicular to the vertical penetration hole 54d.

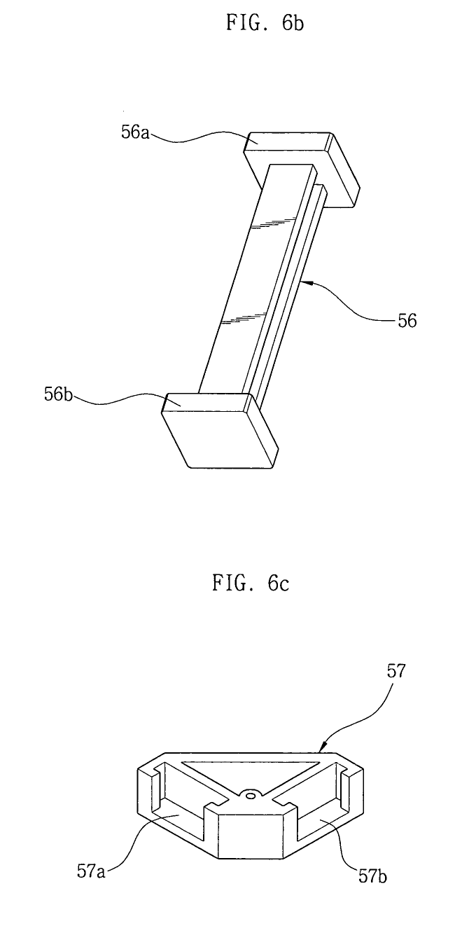

As shown in FIGS. 6A and 6B, each of the sixth and seventh joint parts 55 and 56 has rectangular insertion pieces 55a, 55b, 56a, 56b formed at both ends of a shaft thereof such that when the one joint mechanism part 40 is coupled with the another joint mechanism parts, the rectangular insertion pieces 55a, 55b, 56a, 56b are inserted into the insertion part 42b of the joint mechanism part 40. Herein, the shaft of the sixth joint part 55 is short in length between both insertion pieces 55a and 55b, while the shaft of the seventh joint part 56 is long in length between both insertion pieces 56a and 56b.

As shown in FIG. 6c, the eighth joint part 57 is an approximately triangular plate shape having a constant thickness, and has rectangular insertion holes 57a, 57b arranged at an angle of 90 degrees so as to connect one joint mechanism part 40 with other joint mechanism parts. The rectangular holes 57a and 57b is characterized in that each of which outer surface is opened.

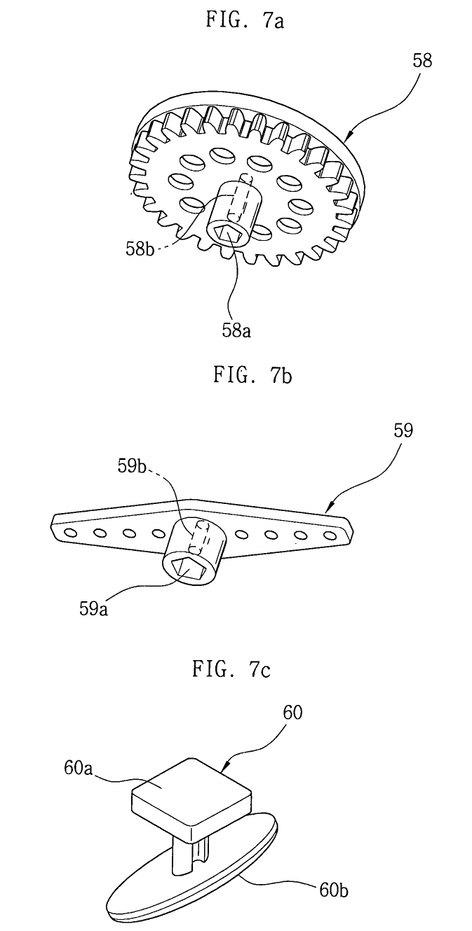

Also, as shown in FIGS. 7A and 7B, the ninth and tenth joint parts 58 and 59 are inserted onto the coupling shaft 31a of the joint mechanism parts 40 to function as a wheel or a wing, and each of them has a pentagonal insertion hole 58a, 59a formed protruding from a center portion thereof. Also, each of the ninth and tenth joint parts 58 has an axial hole 58b, 59b penetrating the pentagonal insertion groove 58a, 59a.

Lastly, the eleventh joint part 60, as shown in FIG. 7c, is inserted into the insertion part 42b of the joint mechanism parts 40 to serve as a foot of the robot toy, and has a rectangular insertion piece 60a at one end of a shaft thereof and a hemispherical rolling part 60b, which is wider in area than the insertion piece 60a.

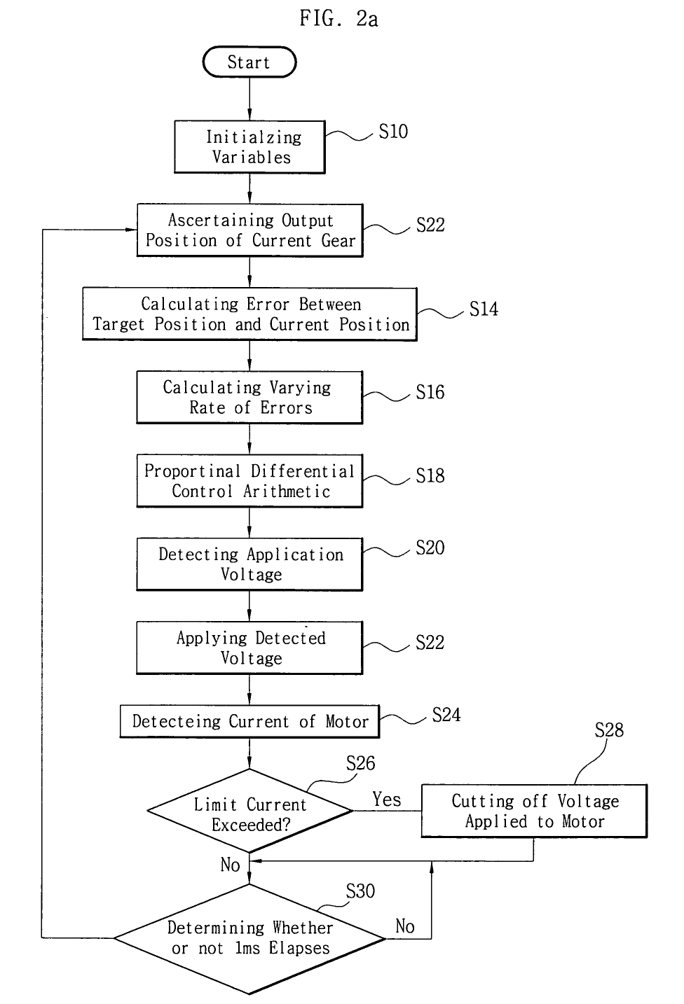

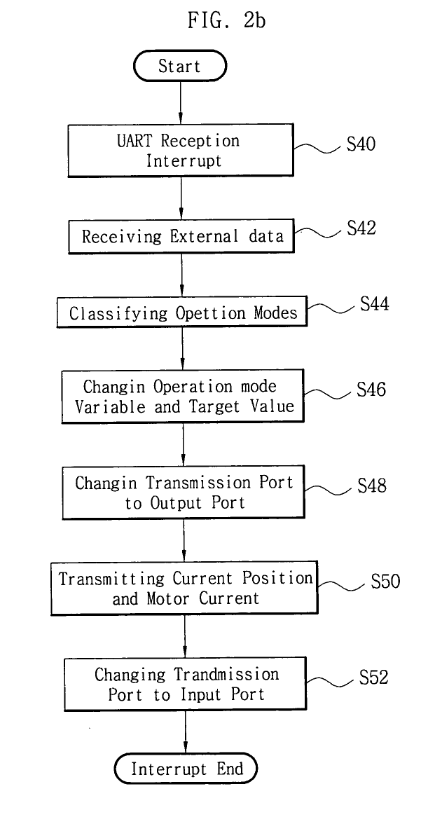

Hereinafter, preferred embodiments having the above construction according to the present invention will be described in detail with reference to FIGS. 1 to 20.

To assemble various shapes of robots needing a motion using one kind of joint mechanism part, as shown in FIGS. 3A and 3B, the housing 42 is received in the lower case 41 having the guide part 41a at one side thereof and the opening 41b at the other side thereof. At this time, the housing 42 houses the motor 30, the gear part 31, and the joint control part 20. Alternatively, the master main-processor unit board 10, etc., is coupled in the housing 42. After that, the upper case 43 is covered on the lower case 41. The upper case 43, the lower case 41 and the housing 42 are stably fixed by screwing four screws, so that one joint mechanism part 40 is formed. At this time, the coupling shaft 47 coupled with the third gear 31c of the gear part 31, is positioned at the slot 43a of the upper case 43, and the gear shaft 42a and the insertion part 42b of the housing 42 are protruded respectively toward the guide part 41a of the lower case 41 and the opening part 41b of the lower case 41.

To assembly a desired shape of robot toy using a plurality of joint mechanism parts each having the above construction, there are needed the first to eleventh joint parts 50 to 60 as shown in FIGS. 4 to 7.

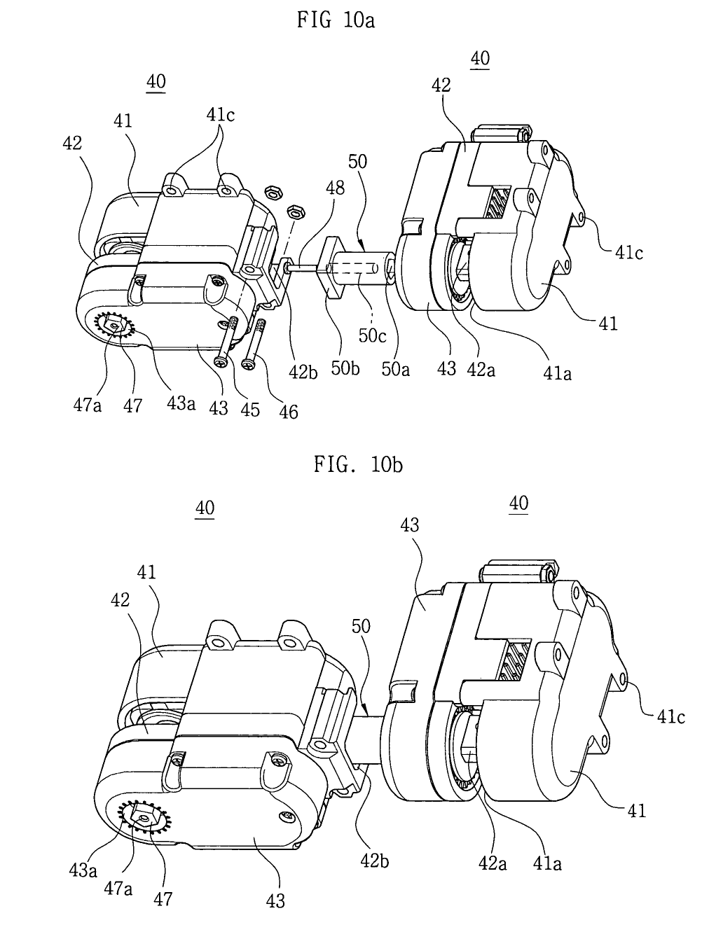

The first joint part 50 shown in FIG. 4A has the pentagonal insertion groove 50a formed at one end of the shaft thereof and the rectangular insertion piece 50b formed at the other end of the shaft thereof, and is, as shown in FIGS. 10A and 10B, used to connect the coupling shaft 47 of one joint mechanism part 40 with the insertion part 42b of the other joint mechanism parts. In other words, as shown in FIG. 10A, the first joint part 50 is inserted onto the coupling shaft 47 of one joint mechanism part 40 through the insertion groove 50a thereof, and then a screw 48 is screwed with the screw hole 47a of the coupling shaft 47 through the insertion groove 50a of the first joint part 50, so that the first joint part 50 is coupled with the coupling shaft 47 of the joint mechanism part 40. Thereafter, the insertion piece 50b of the first joint part 50 is inserted into the insertion part 42b of another joint mechanism part, and then two screws 45 and 46 are inserted into the screw holes 45a and 46a formed in the insertion part 42b and are then screwed by nuts, so that two joint mechanism parts are assembled as shown in FIG. 10B.

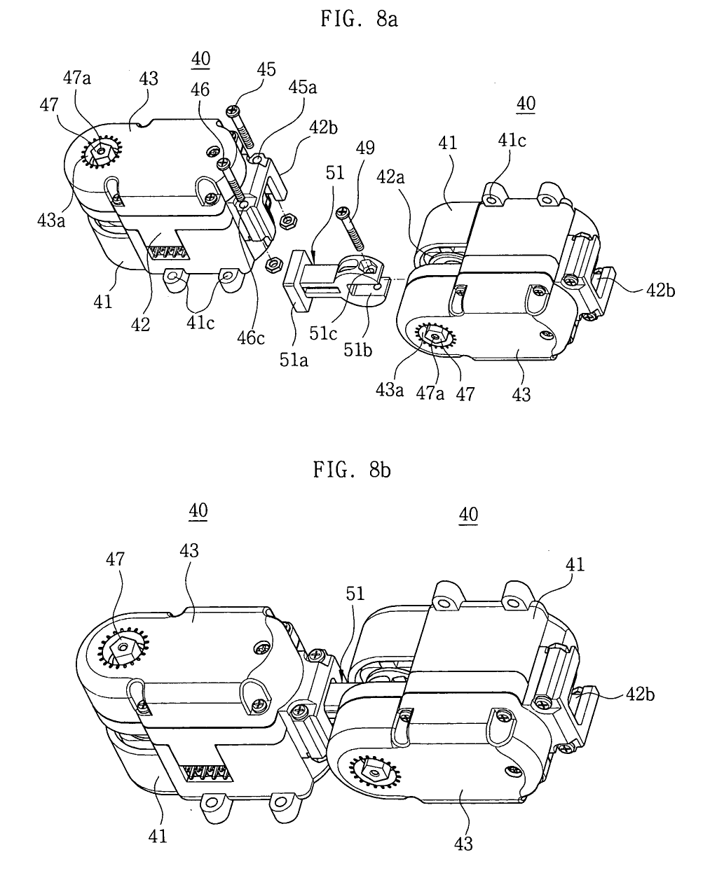

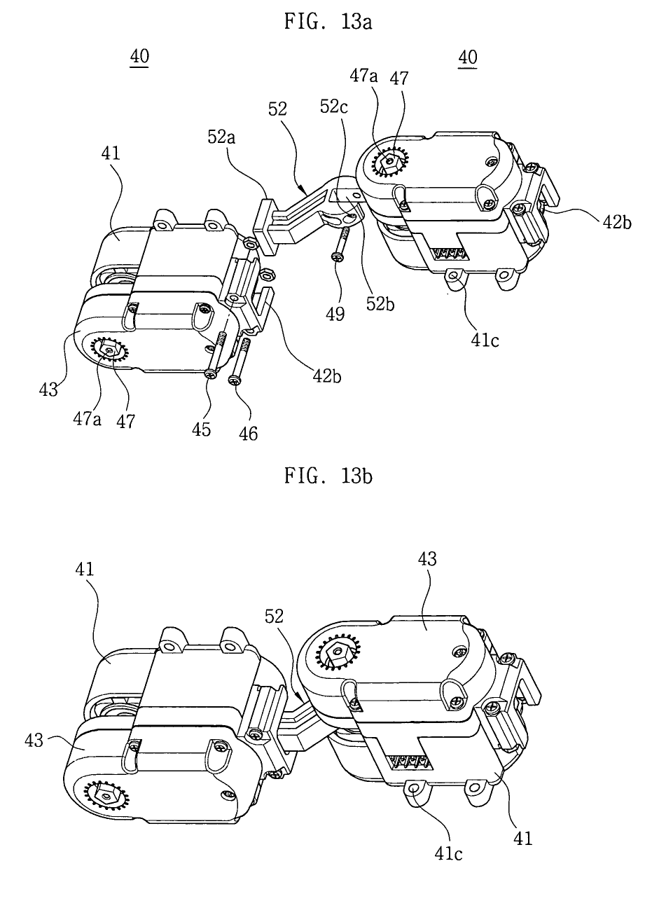

Each of the second and third joint parts 51 and 52 shown in FIGS. 4b and 4c has the spanner type insertion hole 51b, 52b formed at one end of the shaft thereof and the rectangular insertion piece 51a, 52a formed at the other end of the shaft, and is, as shown in FIGS. 8a, 8b, 13a and 13b, used to connect the gear shaft 42a of one joint mechanism part 40 with the insertion part 42b of other joint mechanism parts. In other words, as shown in FIGS. 8a and 13a, the second and third joint parts 51 and 52 are inserted onto the gear shaft 42a of one joint mechanism part 40 through the insertion holes 51b and 52b thereof, and then a screw 49 is inserted into the axial holes 51c and 52c of the insertion holes 51b and 52b, and the screw hole 42c of the gear shaft 42a corresponding to the axial holes 51c and 52c, and is screwed so that the second and third joint parts 51 and 52 are not released from the gear shaft 42a. After that, the insertion pieces 51a and 52a of the second and third joint parts 51 and 52 are coupled in the same manner as that of the first joint part 50, so that an assembly is completed as shown in FIGS. 8B and 13B.

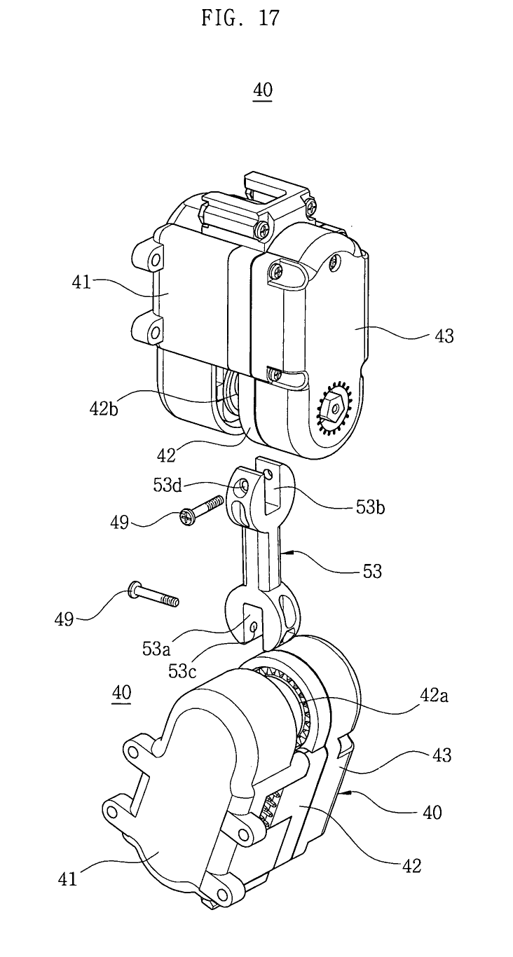

The fourth joint part 53 shown in FIG. 5A has spanner type insertion holes 53a and 53b formed at both ends of the shaft thereof, and is, as shown in FIG. 17, used to connect the gear shaft 42a of one joint mechanism part 40 with the gear shaft 42a of other joint mechanism parts. Here, the coupling method of both the insertion holes 53a and 53b is the same as that coupling the insertion holes 51b and 52bof the second and third joint parts 51 and 52 to the gear shaft 42a.

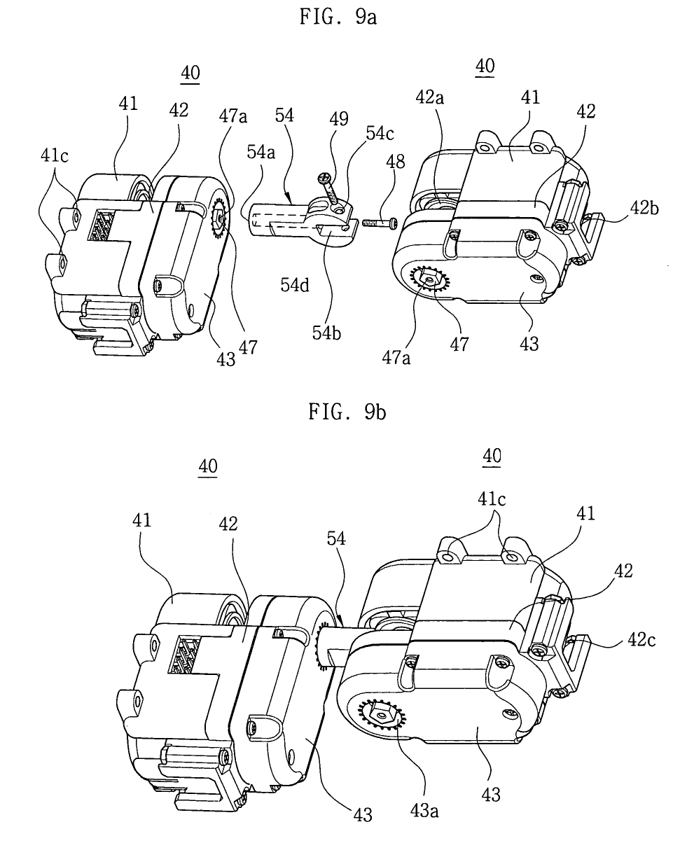

Like the fourth joint part 53, the fifth joint part 54 shown in FIG. 5B has the pentagonal insertion groove 54a formed at one end of the shaft thereof and the spanner type insertion hole 54b formed at the other end of the shaft thereof, and as shown in FIGS. 9A and 9B, is inserted onto the coupling shaft 47 through the slot 43a of one joint mechanism part at the insertion groove 54a thereof, and the insertion hole 54b is inserted onto the gear shaft 42a through the guide part 41a of the other joint mechanism parts an coupled. At this time, the pentagonal insertion groove 54a is coupled in the same manner as the insertion groove 50a of the first joint part 50, and the spanner type insertion hole 54b is coupled in the same manner as the insertion hole 51b of the second joint part 51 is coupled with the gear shaft 42a.

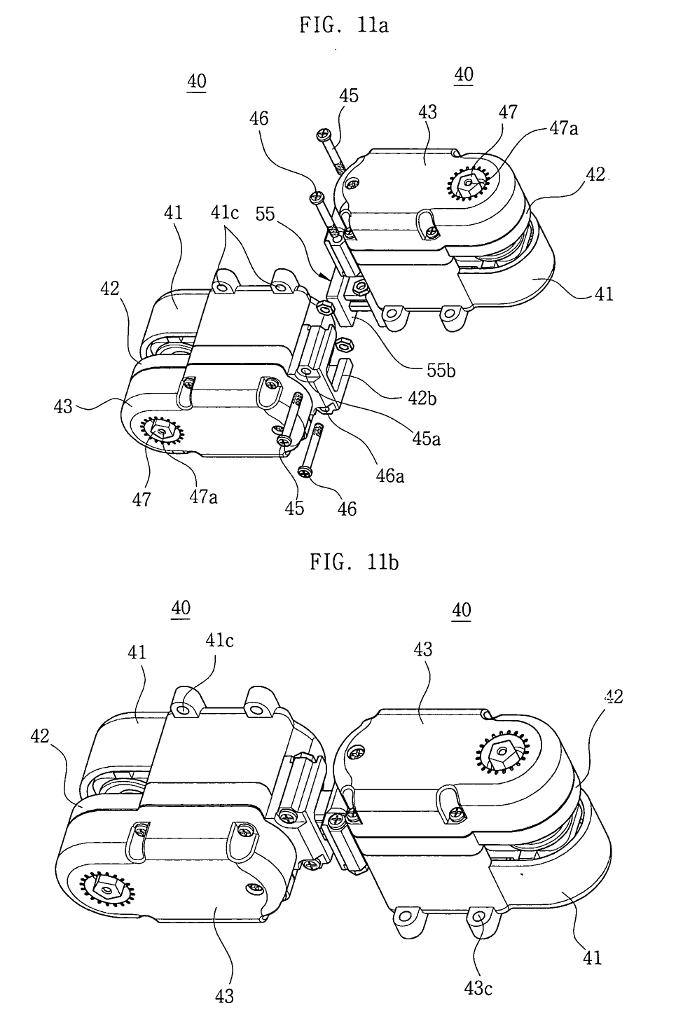

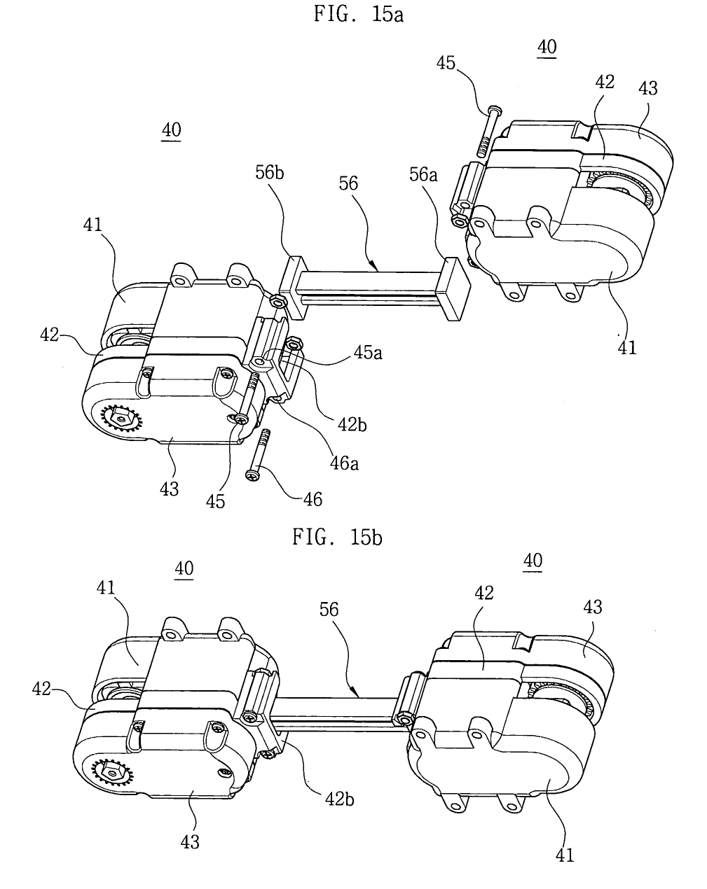

Each of the sixth and seventh joint parts 55 and 56 shown in FIGS. 6A and 6B has rectangular insertion pieces 55a, 55b, 56a, 56b formed at both ends of the shaft thereof, and are, as shown in FIGS. 11A, 11B, 15A and 15B, respectively inserted into the insertion part 42b of one joint mechanism part and the insertion part of another joint mechanism part and coupled. Here, the sixth joint part 55 has the short shaft between both insertion pieces 55a and 55b, while the seventh joint part 56 has the shaft longer than the sixth joint part 55. The coupling method of the sixth and seventh joint parts 55 and 56 are the same as the method coupling the insertion piece 51a of the second joint part 51 to the insertion part 42b.

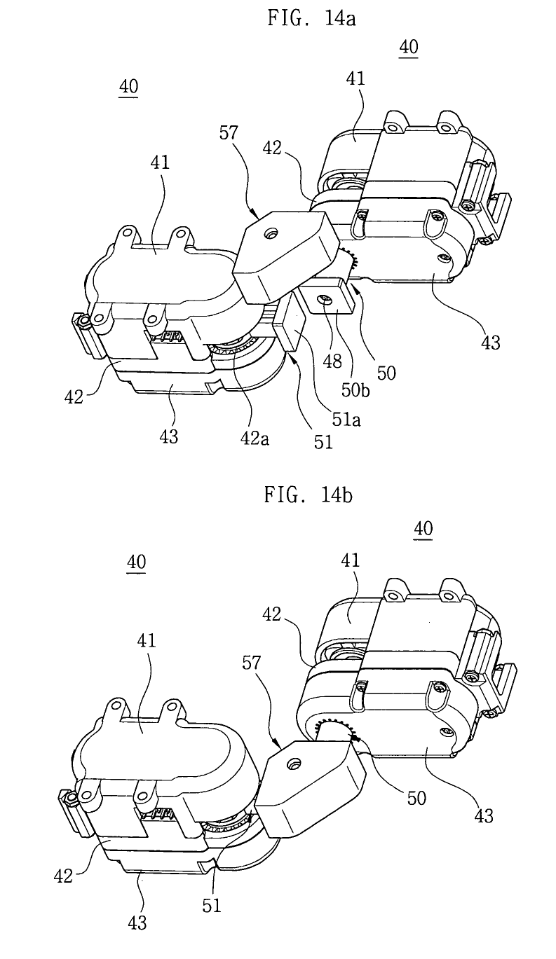

The eighth joint part 57 shown in FIG. 6c has the rectangular insertion holes 57a, 57b arranged at an angle of 90 degrees, and is, as shown in FIGS. 14A and 14B, used to rotatably connect the gear shaft 42a of one joint mechanism part 40 with the coupling shaft 47 of other joint mechanism parts. In other words, in a state that the insertion groove 50a of the first joint part 50 and the insertion hole 51b of the second joint part 51 are coupled in the aforementioned manner, the insertion holes 57a and 57b of the eighth joint part 57 are forcibly inserted and coupled with the insertion pieces 50b and 51a of the first and second joint parts 50 and 51, so that the assembly is completed as shown in FIG. 14B.

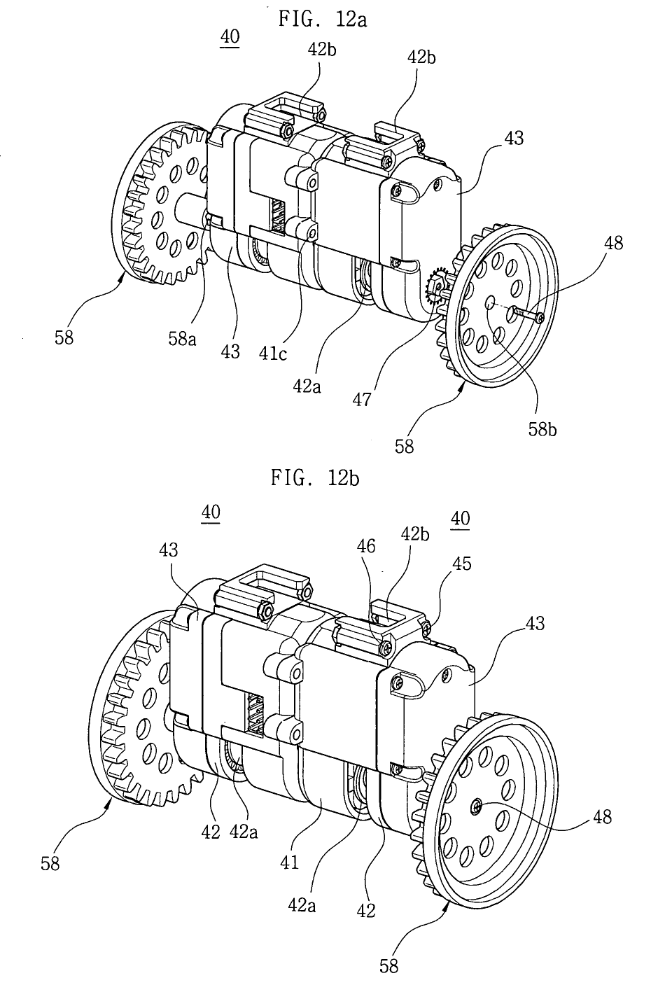

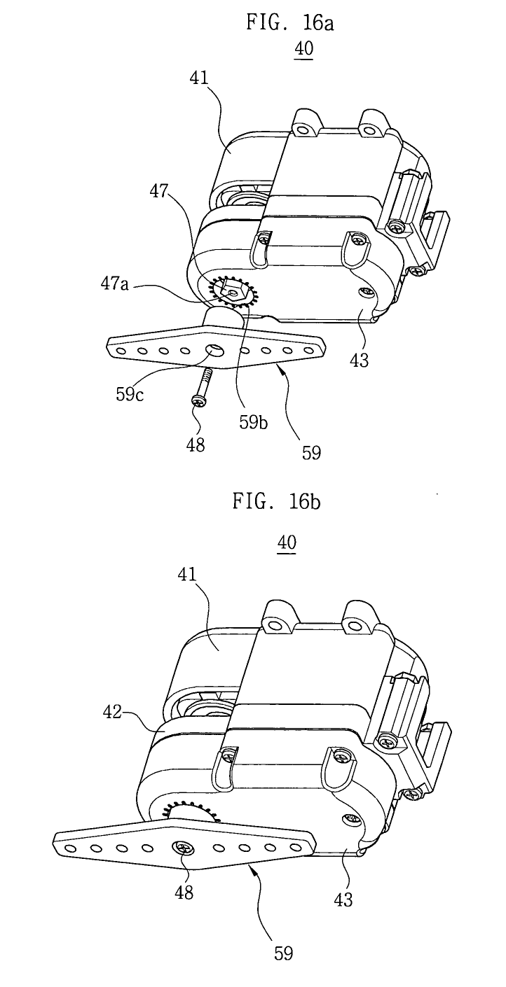

Each of the wheel type ninth joint part 58 and the wing type tenth joint part 59 shown in FIGS. 7A and 7B has the pentagonal insertion hole 58a, 59a formed protruding from a center portion thereof, and is, as shown in FIGS. 12A, 12B, 16A and 16B, inserted onto the coupling shaft 47 of the joint mechanism part 40 to serve as a wheel or a wing. First, two joint mechanism parts are contacted with each other, and a screw is inserted into the coupling hole 41c and screwed so that the two joint mechanism parts are stably coupled. After that, the insertion grooves 58a, 59a of the ninth and tenth joint parts 58 and 59 are inserted onto the coupling shaft 47 of the two joint mechanism parts 58 and 59 and a screw is inserted into the axial holes 58b, 59b of the insertion grooves 58a, 59a and screwed so that the assembly is completed as shown in FIGS. 12B and 16B. In particular, the tenth joint part 59 is coupled with the joint mechanism 40 and is advantageous in climbing steps having a low height difference while rotating.

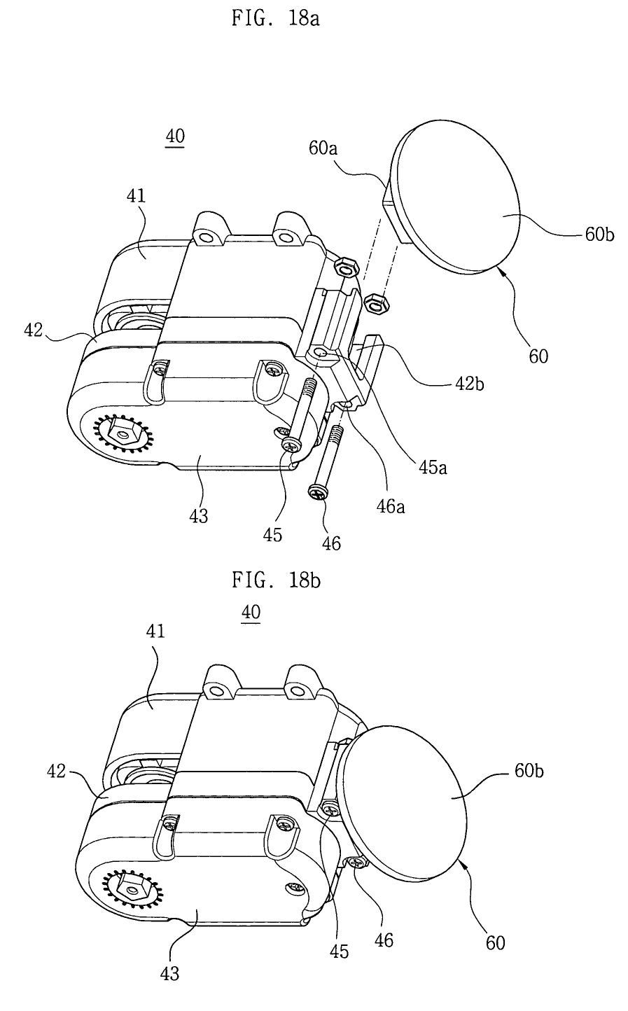

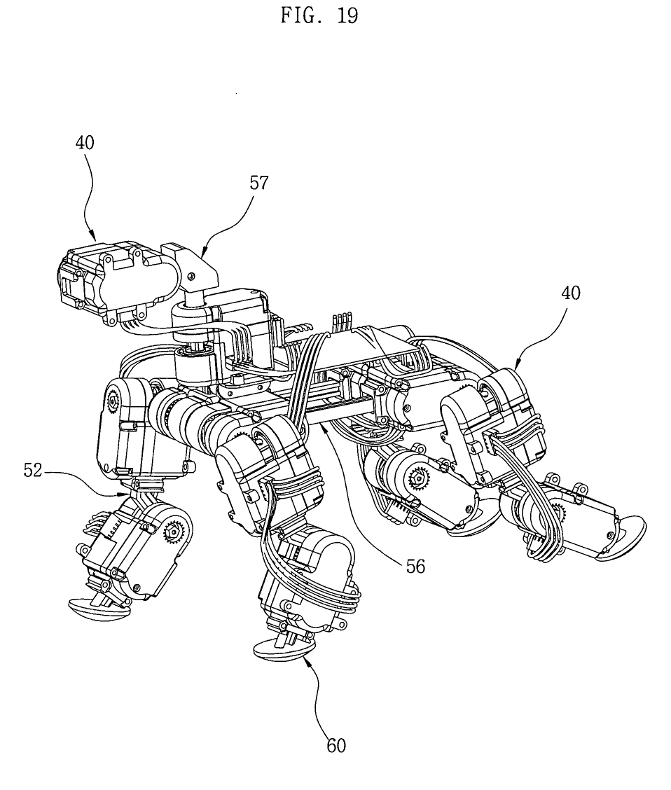

The eleventh joint part 60 shown in FIG. 7c has the rectangular insertion piece 60a at one end of the shaft thereof and the hemispherical rolling part 60b at the other end of the shaft thereof, which is wider in area than the insertion piece 60a, and is, as shown in FIGS. 18A and 18B, used inserted into the insertion part 42b of the joint mechanism parts 40. In particular, the rolling part 60b serve as a foot of the robot toy during the movement of the robot toy, and the insertion piece 60a is coupled in the same manner as that of the aforementioned joint parts so that the assembly is completed as shown in FIG. 18B.

Also, the plurality of joint mechanism parts 40 are coupled in series or parallel through two power lines, a single transmission line and a reception line, and are mounted on the master main-processor unit board 10.

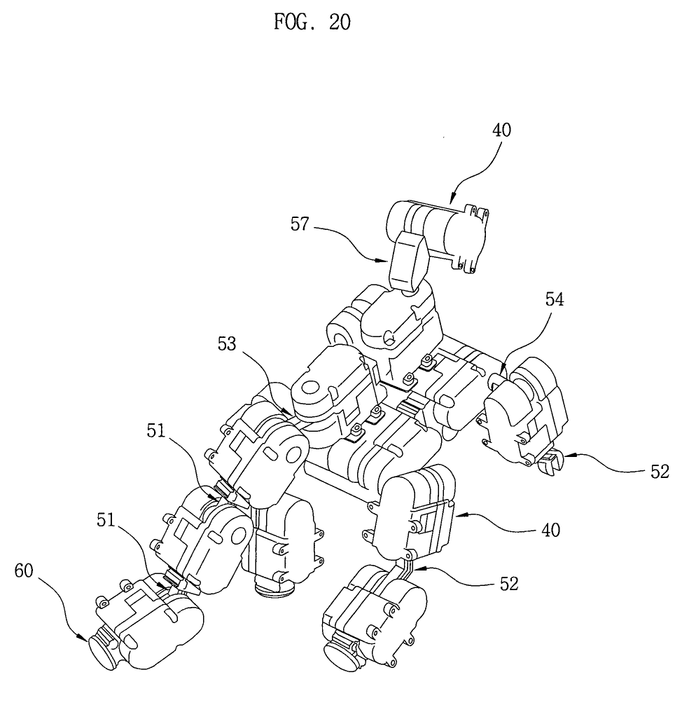

Thus, the first to eleventh joint parts 50 to 60 are selectively used according to the shapes of the robot toys desired for assembling, to couple the plurality of joint mechanism parts 40 sequentially. After a desired robot toy needing a motion as shown in FIG. 19 or FIG. 20 is assembled, if an operation starts through a switch (not shown in the drawings), the master main-processor unit board 10 received in one joint mechanism part reads in a current position from the main-process unit 24 of the joint control part 20 received in the plurality of joint mechanism parts 40, i.e., reads in the angle of the joint through the reception port (Rx) of one line if the joint mechanism part 40 is a hand, reads in a moved distance through the reception port (Rx) of one line if the joint mechanism part 40 is a foot, and reads in a moved angle through the reception port (Rx) of one line if the joint mechanism part 40 is tail or head.

Then, the action mode (operation mode) of each of the joint mechanism parts 40 is set in a motor down mode. Thereafter, a command is transmitted to each of the joint mechanism parts 40 through the transmission port (Tx) of one line, and then current position and current are received through the reception port (Rx) of one line.

After the current position of each of the joint mechanism parts 40 is ascertained, preset target position and velocity are computed on the basis of the received current position and then the computed new target position and sampling time (velocity value, i.e., motion angle of joint) are transmitted through the transmission port (Tx) in accordance with communication protocol. After that, the action mode (operation mode) of the plurality of joint mechanisms 40 is set in a position sense mode, and then a command is transmitted to the respective joint mechanism parts 40. In other words, directly after the target position and velocity value are transmitted, the present position and the present current are received to ascertain whether or not there exists a variation between the previous position and the present position, and also to ascertain the state of the present current. Afterwards, a new action is planned using the ascertained position variation and the current state information. If the plan is completed, steps of computing next target position and velocity of each of the joint mechanism parts suitable for new actions, i.e., steps of computing the motion angle of the joints, are repeatedly performed.

In the meanwhile, the main-processor unit 24 of the joint control part 20 received in each of the joint mechanism parts 40 initializes variables if an operation starts through a switch (S10).

After the initialization is released, the main-processor unit 24 ascertains a current output position of the gear part 31 through the third A/D converter 33 and the rotation sensing part 32 (S12), and calculates an error between the new target position provided by the master main-processor unit board 10 and the ascertained current position (S14). Then, variation rate in the calculated errors is computed (S16) and a proportional differential control arithmetic is performed (S18).

After that, a non-driving voltage provided from the master main-processor unit board 10 is detected through the inverse voltage preventing part 21, the voltage detecting part 25 and the first A/D converter 26 (S20), and a real voltage applied to the motor 30 is calculated from the proportional differential arithmetic value and the level of the detected non-driving voltage. The calculated voltage is modulated to a PWM signal, and the PWM signal is applied to the motor 30 through the motor driving part 27 together with the direction (DIR) signal to drive the motor 30 (S22).

When the motor 30 is driven, the first to third gears 31a, 31b, 31c of the gear part 31 of the corresponding joint mechanism part 40 rotate, the corresponding joint mechanism part coupled to the gear shaft 42a and the coupling shaft 47 through the first to eleventh joint parts 50 to 60 traces the target position provided from the master main-processor unit board 10.

In the above, if the joint mechanism part corresponds to a hand, the angle of the joint traces the target position. If the joint mechanism part corresponds to a foot, the moved distance traces the target position. If the joint mechanism part corresponds to tail or head, left and right motion angles trace the target position.

Thus, in a state that the respective joint mechanism parts 40 are moved by the motor 30 and the gear part 31, the main-processor unit 24 detects the current of the motor 30 through the current detecting part 28 and the second A/D converter 29 (S24) and determines whether or not the detected current exceeds a set limitation current (S26). If it is determined that the detected current exceeds the set limitation current, the main-processor unit 24 cuts off the voltage applied to the motor 30 (S28). If it is determined that the detected current does not exceed the set limitation current, the main-processor unit 24 determines whether or not the limitation current exceeds 1ms, i.e., repetition routine time elapses (S30). If it is determined that the limitation time does not exceeds the repetition routine time, the main-processor unit 24 maintains the standby state, while if it is determined that the limitation time exceeds the repetition routine time, the main-processor unit 24 repeatedly performs the steps after the step S10.

Thus, while performing motions with tracing the target position provided from the master main-processor unit board 10, if interrupt is generated (S40), the main-processor units 24 of the joint control parts 20 received in the respective joint mechanism parts 40 receive data through the reception port (Rx) (S42), and classify operation modes to be described later (S44).

Also, the main-processor units 24 change the operation mode variables and the target position (S46), and change the transmission port (Tx) thereof to an output port (S48). Herein, the main-processor unit 24 receives data from the master main-processor unit board 10 by using the transmission port (Tx) as an input port in a normal state, and if each operation thereof is ended, the main-processor unit 24 changes the transmission port (Tx) to the output port so as to transmit the result of the respective operations in the format of data.

Next, after changing the transmission port (Tx) to the output port, the main-processor unit 24 detects the current position of the motor 30, i.e., the current position of the corresponding joint mechanism part 40 and the current of the motor 30, and transmits the detected results to the master main-processor unit board 10 through the changed output port (S50) . After transmitting the detected current position and current, the main-processor unit 24 changes the transmission port (Tx) to the input port (S52), and completes the interrupt operation.

The aforementioned operation modes are classified into position send mode, motor down mode, power down mode and wheel act mode.

The position send mode indicates an operation mode in which the motor 30 is operated for the position control, a position control range is 0-332.3°, and the present position and current thereof are transmitted after the position control command is received.

The motor down mode indicates a mode in which the motor power is changed to zero, a user can arbitrarily change the motor position by his (or her) power, and the present position and current return to after a command is received. The motor down mode operates as a sensor used for changing the position by an external force.

The power down mode is used for minimizing the operation power consumption of the motor system and the system power. The power down mode returns the IDs and positions of the corresponding joint mechanism parts 40 after receiving a command, and is used to want to know the motor IDs of the corresponding joint mechanism parts 40.

Lastly, the wheel act mode operates the motor to drive the wheel, makes it possible to rotate the wheel clockwise or counterclockwise by an angle of 360° and control the velocity of the wheel. In the wheel act mode, rotation amount and present position are transmitted after a command is received.

The aforementioned operation modes receive commands from the master main-processor unit board 10.

From the above descriptions, unlike the conventional art, which does not allow a user to expandably assemble one set of robot toy as various shapes of robot toys, for instance, puppy robot, dinosaur robot, or android, it can be well known that it is possible to expandably assemble various shapes of robot toys needing motions by using a plurality of joint mechanism parts corresponding to one kind.

As described above, robot toys according to the present invention provide users with love and interest. Also, it is possible to address all functions of such robot toys to a maximum degree at a low manufacturing cost and to assemble and control the robot toys requesting motions in various shapes with ease by using one kind of joint mechanism part. Further, the inventive robot toys provide users with easy disorder coping and expandable assembling capability.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An artificial intelligence robot toy comprising:
a plurality of joint mechanism parts assemblable and disassemblable to form various shapes of robots;
a master main-processor unit board provided in one of the plurality of joint mechanism parts, for outputting a robot control signal such that another joint mechanism parts have a predetermined operation pattern;
a plurality of joint control means respectively provided in the remaining joint mechanism parts other than the selected joint mechanism part, for transmitting and receiving data to and from the master main-processor unit board while operating the corresponding joint mechanism parts by using at least one pattern, based on the operation pattern of the master main-processor unit board; and
a joint means for coupling the plurality of joint mechanism parts so as to form the various shapes of robots.

2. The artificial intelligence robot toy of claim 1, wherein the joint mechanism part comprises:
a lower case provided with a guide part formed at one end thereof, an opening formed at the other end thereof, and a coupling hole formed at an outer wall thereof such that the joint means is inserted;
a housing coupled in the lower case, for stably supporting the master main-processor unit board or the joint control means, the housing having a gear shaft coupled with the joint means at one end of the housing and protruded in a vertical direction to be rotatable, and an insertion part onto which the joint means is inserted;
an upper case coupled with the lower case and having an slot formed at a side sealingly closing the housing; and
a coupling shaft extending from an end of the gear shaft and protruded through the slot of the upper case, the coupling shaft being coupled with the joint means.

3. The artificial intelligence robot toy of claim 1, wherein the joint control means comprises:
an inverse power preventing part supplied with a non-driving voltage to prevent an inverse voltage;
a constant voltage part for converting and outputting the output non-driving voltage of the inverse power preventing part to a constant level of digital voltage;
a filter part for filtering a noise including a ripple voltage from the supply voltage of the constant voltage part and supplying a filtered voltage;
a voltage detecting part for detecting level of the non-driving voltage obtained from the inverse power preventing part;
a motor coupled to the housing of the joint mechanism part and rotating clockwise or counterclockwise;
a motor driving part for controlling and driving the motor in a pulse width modulation (PWM) way according to the voltage obtained by the constant voltage part and the inverse power preventing part;
a gear part coupled to a shaft of the motor, for decelerating a rotational ratio of the motor, transferring the decelerated rotational ratio to the gear shaft, and controlling the operation pattern of the joint mechanism part;
a rotation sensing part driven by the supply voltage of the filter part, for sensing the rotation of the gear part;
a current detecting part for detecting a load current of the motor through the motor driving part;
first to third A/D converters for converting and outputting the output signals of the voltage detecting part, the current detecting part and the rotation sensing part to digital signals respectively; and
a main-processor unit for outputting a PWM signal and a direction signal depending on operation modes provided from the master main-processor unit board to drive the motor and respectively computing the voltage level, the current level and the rotational ratio obtained by the first to third A/D converters and transmitting the computed voltage level, the current level and the rotational ratio to the master main-processor unit board.

4. The artificial intelligence robot toy of claim 1, wherein the one master main-processor unit board and the plurality of main-processor units are connected in series through a single transmission port and a single reception port to transmit and receive data.

5. The artificial intelligence robot toy of claim 1, wherein the joint means has a spanner type insertion hole formed at one end of a shaft and a rectangular insertion piece formed at the other end of the shaft so as to be inserted onto the gear shaft and the insertion parts of the another joint mechanism parts through the guide part of the one joint mechanism part.

6. The artificial intelligence robot toy of claim 5, wherein the spanner type insertion hole of the joint means is inclined at a predetermined angle by the shaft with respect to the rectangular insertion piece.

7. The artificial intelligence robot toy of claim 5, wherein the spanner type insertion hole of the joint means is arranged straightly by the shaft with the rectangular insertion piece.

8. The artificial intelligence robot toy of claim 1, wherein the joint means is a cylindrical shaft having a predetermined length, the cylindrical shaft having a pentagonal insertion groove formed at one end thereof and a rectangular insertion piece formed at the other end thereof such that the joint means is inserted onto the coupling shaft through the slot of one of the joint mechanism parts and inserted into the insertion parts of the another joint mechanism parts.

9. The artificial intelligence robot toy of claim 1, wherein the joint means has a spanner type insertion hole formed at both ends of a shaft of the joint means such that the joint means is inserted onto the gear shaft through the gear shaft of the one joint mechanism part and the guide parts of the another joint mechanism parts.

10. The artificial intelligence robot toy of claim 9, wherein the both insertion holes of the joint means are arranged at an angle of 90 degrees therebetween.

11. The artificial intelligence robot toy of claim 1, wherein the joint means is a shaft having a pentagonal insertion groove formed at one end thereof and a rectangular insertion piece formed at the other end thereof such that the joint means is respectively inserted onto the coupling shaft through a slot of the one joint mechanism part and into the gear shaft through the guide parts of the another joint mechanism parts.

12. The artificial intelligence robot toy of claim 1, wherein the joint means has a rectangular insertion piece formed at both ends of a shaft thereof such that when the one joint mechanism part is coupled with the another joint mechanism parts, the joint part is inserted into the insertion parts of the another joint mechanism parts.

13. The artificial intelligence robot toy of claim 12, wherein the joint means has a short shaft which the length between the both insertion pieces is short.

14. The artificial intelligence robot toy of claim 12, wherein the joint means has a long shaft which the length between the both insertion pieces is long.

15. The artificial intelligence robot toy of claim 1, wherein the joint means has a pentagonal insertion groove protruded at a center thereof such that the joint means is inserted onto the coupling shafts of the joint mechanism parts.

16. The artificial intelligence robot toy of claim 15, wherein the joint means is shaped in a wheel.

17. The artificial intelligence robot toy of claim 15, wherein the joint means is shaped in a wing.

18. The artificial intelligence robot toy of claim 1, wherein the joint means has a rectangular insertion piece formed at one end thereof and a hemispherical rolling part formed at the other end thereof, inclined at a predetermined angle with respect to the insertion piece and having a wide area such that the joint means is inserted into the insertion parts of the joint mechanism parts.

19. The artificial intelligence robot toy of claim 1, wherein the joint means has rectangular insertion holes arranged at an angle of 90 degrees on one surface thereof so as to connect the one joint mechanism part and the another joint mechanism parts.

20. A method for controlling an artificial intelligence robot toy, the method comprising the steps of:
(a) determining a current position of joints from a rotation sensing part informing a current position of joint mechanism parts;
(b) obtaining an error from the determined current position and a target position provided by a master main-processor unit board;
(c) computing a variation rate of the obtained error and then performing a proportional differential control arithmetic of the computed variation rate;
(d) calculating an application voltage of motors provided from the master main-processor unit board and detecting a current of the motors while supplying the calculated voltage; and
(e) determining whether or not the detected current exceeds a limit current, when it is determined that the detected current exceeds the limit current, cutting off the voltage applied to the motors, and when it is determined that the detected current does not exceed the limit current, repeating the steps after the step (a).

21. The method of claim 20, further comprising the steps of:
when an interrupt is generated from the master main-processor unit board, changing a current operation mode variable and a target value, changing a transmission port to an output port, and transmitting the detected current position of the joints and the current of the motors; and
after transmitting the detected current position of the joints and the current of the motors, changing the transmission port to an input port.
